(19) United States
(12) Patent Application Publication
(10) Pub. No.: US 2026/0079436 A1
(43) Pub. Date: Mar. 19, 2026

(54) BOOKLET MAKING APPARATUS THAT MAKES BOOKLET BY BONDING TOGETHER PLURALITY OF SHEETS, AND IMAGE FORMING SYSTEM

(71) Applicant: CANON KABUSHIKI KAISHA, Tokyo (JP)

(72) Inventor: KOJI KAWAMURA, Kanagawa (JP)

(21) Appl. No.: 19/322,909

(22) Filed: Sep. 9, 2025

(30) Foreign Application Priority Data
Sep. 13, 2024 (JP) 2024-159414

(51) Int. Cl. G03G 15/00; B42C 3/00

(52) U.S. Cl. CPC G03G 15/6544; B42C 3/00; G03G 15/6585; G03G 2215/00835; G03G 2215/00856; G03G 2215/00936

(57) ABSTRACT

A booklet making apparatus comprises a heating and pressing unit that heats and presses an adhesive layer in a state where a plurality of sheets on which the adhesive layer has been formed are layered. The heating and pressing unit includes a pressing plate, a heating body that heats the pressing plate, a reception member, and a pressing mechanism. A booklet is made by heating and pressing the adhesive layer while holding the plurality of sheets on which the adhesive layer has been formed between the pressing plate and the reception member. The pressing mechanism applies pressure to the plurality of sheets held between the pressing plate and the reception member by pressing the pressing plate without applying a force to the heating body.

### BACKGROUND

### Field of the Technology

The present disclosure relates to a booklet making apparatus that makes a booklet by bonding together a plurality of sheets, and an image forming system.

### Description of the Related Art

A booklet making apparatus makes a booklet by stapling a plurality of sheets, on which images have been printed, with use of an electric stapler. However, metallic staples prevent recycling of booklets. Japanese Patent Laid-Open No. 2005-162352 proposes a thermocompression bonding apparatus that makes a booklet by forming, on sheets, a toner image for bonding (an adhesive layer) together with an image prepared by a user, and heating and pressing a plurality of layered sheets.

The thermocompression bonding apparatus of Japanese Patent Laid-Open No. 2005-162352 presses and heats a bundle of sheets composed of a plurality of sheets with use of a fixing film to which a ceramic heater is firmly pressed, thereby bonding together the bundle of sheets. Therefore, each time sheets are pressed, a high pressure is applied to the ceramic heater. In order to improve the productivity of a booklet making apparatus, the ceramic heater needs to collide against a bundle of sheets at high speed, and become separated from the bundle of sheets at high speed. As thermocompression bonding processing is executed repeatedly, the ceramic heater receives a force of high impact many times. As a result, a product life of the thermocompression bonding apparatus can be shortened.

### SUMMARY

The present disclosure provides a booklet making apparatus, comprising a long thin heating and pressing unit that heats and presses an adhesive layer in a state where a plurality of sheets on which the adhesive layer has been formed are layered. The heating and pressing unit includes a pressing plate that comes into contact with and presses the plurality of sheets, a heating body that heats the pressing plate, a reception member that opposes the pressing plate, and a pressing mechanism that applies pressure to the plurality of sheets held between the pressing plate and the reception member. A booklet is made by heating and pressing the adhesive layer while holding the plurality of sheets on which the adhesive layer has been formed between the pressing plate and the reception member. The pressing mechanism applies pressure to the plurality of sheets held between the pressing plate and the reception member by pressing the pressing plate without applying a force to the heating body.

Features of the present disclosure will become apparent from the following description of embodiments with reference to the attached drawings.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a diagram for describing an image forming system.

FIGS. 2A to 2C are diagrams for describing a position on which toner for bonding is formed.

FIGS. 3A to 3D are diagrams for describing alignment processing.

FIG. 4 is a cross-sectional diagram for describing a stacking unit.

FIG. 5 is a perspective diagram of a movable unit.

FIG. 6 is a perspective diagram of a thermocompression bonding unit.

FIG. 7 is a cross-sectional diagram of the thermocompression bonding unit.

FIG. 8 is a cross-sectional diagram of a pressing unit.

FIGS. 9A to 9F are diagrams for describing thermocompression bonding processing.

FIG. 10 is a cross-sectional diagram for describing the pressing unit.

FIG. 11 is a cross-sectional diagram for describing the pressing unit.

FIG. 12 is a diagram for describing another image forming system.

### DESCRIPTION OF THE EMBODIMENTS

Hereafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

In the present disclosure, an “image forming apparatus” includes a wide range of apparatuses that form (record) an image on a recording material (recording medium), such as a printer, a copier, a multi-functional peripheral, and a commercial printing device. The image forming apparatus may be an image forming system including a body that forms an image on a recording material, a post-processing apparatus (e.g., a sheet processing apparatus), and a sheet feeding apparatus.

### First Embodiment

### 1. Image Forming System

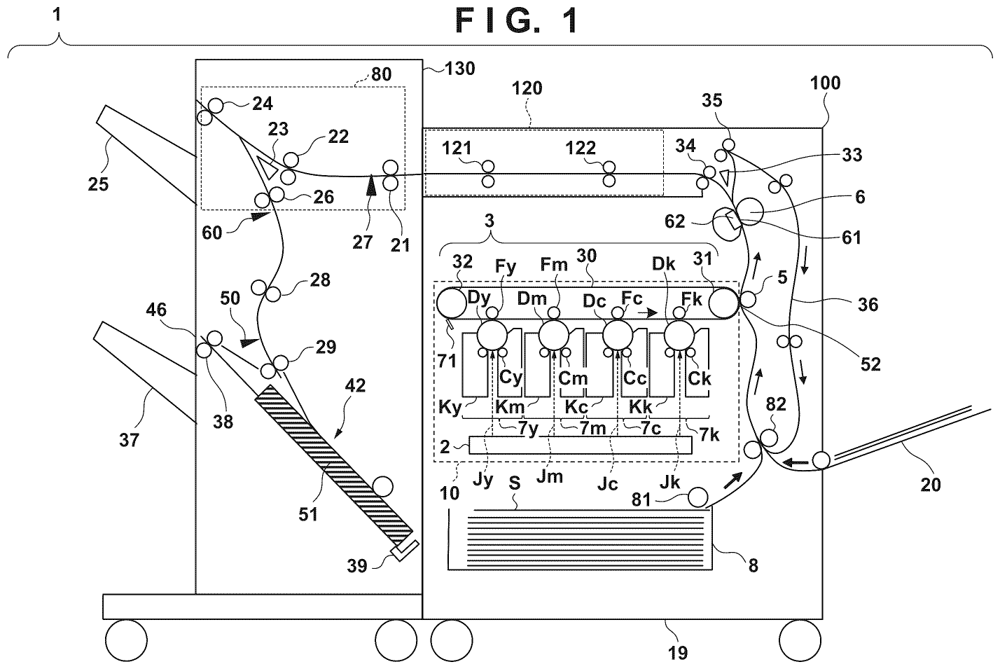

As shown in FIG. 1, an image forming system 1 includes an image forming apparatus 100 and a post-processing apparatus 130. The post-processing apparatus 130 is a sheet processing apparatus connected to the image forming apparatus 100. The image forming apparatus 100 forms an image on a sheet S, which is a recording material. An intermediate conveyance unit 120 conveys the sheet S on which the image has been formed to the post-processing apparatus 130. The post-processing apparatus 130 applies post-processing to the sheet S as necessary, and outputs the sheet S. Note that the image forming system 1 may be understood as a booklet making apparatus, or the post-processing apparatus 130 may be understood as a booklet making apparatus. The image forming system 1 may be referred to as an image forming apparatus.

The image forming apparatus 100 includes a fixing apparatus 6, a sheet cassette 8, an image forming unit 10, and a housing 19 that contains these. The image forming unit 10 forms a toner image on a sheet S fed from the sheet cassette 8. The fixing apparatus 6 executes fixing processing for fixing the toner image on the sheet S.

The sheet cassette 8 is provided in a lower part of the image forming apparatus 100. The sheet cassette 8 is inserted into the housing 19 in a drawable manner, and is also capable of stowing a large number of sheets S. In the present embodiment, it is presumed that the maximum size of sheets S on which an image can be formed is the A4 size (297 mm vertically×210 mm horizontally). A long edge of a sheet S of the A4 size is parallel to a conveyance direction of the sheet S. A feed roller 81 feeds a sheet S from the sheet cassette 8, and passes the sheet S to a conveyance roller pair 82. A multi tray 20 can also feed sheets S one by one.

The image forming unit 10 is a tandem electrophotographic unit that includes four process cartridges 7y, 7m, 7c, and 7k, an exposure apparatus 2, and a transfer unit 3. y, m, c, and k denote yellow, magenta, cyan, and black, respectively. Transparent toner (a powder adhesive) may be adopted in place of the black one. The toner used as the powder adhesive may be referred to as toner Tn for bonding. The characters y, m, c, and k indicating the colors of toner may be omitted in reference signs. The color of toner for bonding may be transparent, or may be black. In a case where the color of toner for bonding is transparent, black is realized by mixing the colors yellow, magenta, and cyan as appropriate (process black). The type (material) of toner in yellow, magenta, and cyan and toner used as toner for bonding is, for example, thermoplastic resin. Examples of thermoplastic resin are polyester resin, vinyl-based resin, acrylic-based resin, styrene/acrylic-based resin, and the like. The process cartridges 7y, 7m, 7c, and 7k enable an integrated exchange of a plurality of components that take a role in an image forming process. That is to say, a plurality of components are integrated to form the process cartridges 7y, 7m, 7c, and 7k. Note that the arrangement of the process cartridges 7y, 7m, 7c, and 7k in the direction of rotation of a transfer belt 30 is merely an example.

The process cartridges 7y, 7m, 7c, and 7k respectively include corresponding development apparatuses Ky, Km, Kc, and Kk, photosensitive drums Dy, Dm, Dc, and Dk, and charging rollers Cy, Cm, Cc, and Ck. The process cartridges 7y, 7m, 7c, and 7k are structured substantially in the same way, except for the type of toner.

The development apparatuses Ky, Km, Kc, and Kk include a container that contains powder (e.g., toner), and an application roller (application sleeve) that applies the powder to the photosensitive drums Dy, Dm, Dc, and Dk. More specifically, the development apparatuses Ky, Km, and Kc contain toner in yellow, magenta, and cyan, respectively, for forming a visible image on a sheet S. The development apparatus Kk contains toner in black (toner Tn for bonding). The toner Tn for bonding may be used to form a user image (a document image), and also for thermocompression bonding of a plurality of sheets S in the post-processing apparatus 130. Note that an image based on the toner Tn for bonding is formed on the photosensitive drum Dk as a result of development using the toner Tn for bonding.

The image forming unit 10 may include a fifth process cartridge that uses toner dedicated for bonding. Note that the type of toner for printing and the number thereof can be changed in accordance with an intended use of the image forming apparatus 100.

The charging rollers Cy, Cm, Cc, and Ck are chargers, and uniformly charge the surfaces of corresponding photosensitive drums Dy, Dm, Dc, and Dk, respectively. The exposure apparatus 2 is arranged underneath the process cartridges 7y, 7m, 7c, and 7k, and above the sheet cassette 8. The exposure apparatus 2 forms electrostatic latent images by irradiating the photosensitive drums Dy, Dm, Dc, and Dk with corresponding laser beams Jy, Jm, Jc, and Jk, respectively. The exposure apparatus 2 may be referred to as an optical scanning apparatus.

The development apparatuses Ky, Km, Kc, and Kk form toner images by causing toner to adhere to the electrostatic latent images on the photosensitive drums Dy, Dm, Dc, and Dk. The development apparatuses Ky, Km, Kc, and Kk may be referred to as a development apparatus.

The transfer unit 3 includes a transfer belt 30 as an intermediate transfer member (a secondary image carrier). The transfer belt 30 is an endless belt wound around an inner roller 31 and a hanging roller 32. An outer circumferential surface (an image forming surface) of the transfer belt 30 opposes the photosensitive drums Dy, Dm, Dc, and Dk. Primary transfer rollers Fy, Fm, Fc, and Fk are arranged on the inner circumferential side of the transfer belt 30 so as to oppose the photosensitive drums Dy, Dm, Dc, and Dk.

The primary transfer rollers Fy, Fm, Fc, and Fk transfer the toner images from the corresponding photosensitive drums Dy, Dm, Dc, and Dk to the transfer belt 30. The primary transfer rollers Fy, Fm, Fc, and Fk may be referred to as primary transfer devices. Counterclockwise rotation of the transfer belt 30 causes the toner images to be conveyed to a secondary transfer unit.

A secondary transfer roller 5 is arranged to oppose the inner roller 31, and forms a transfer nip 52 between the secondary transfer roller 5 and the transfer belt 30. The transfer nip 52 transfers the toner images from the transfer belt 30 to a sheet S. The transfer nip 52 may be referred to as a secondary transfer unit. A cleaning blade 71 is a cleaning member for cleaning toner remaining on the transfer belt 30. Toner scraped off by the cleaning blade 71 is accumulated in a non-illustrated collecting container.

The fixing apparatus 6 is arranged above (in the conveyance direction of the sheet S, downstream relative to) the secondary transfer roller 5. The fixing apparatus 6 applies heat and pressure to the sheet S passing through a fixing nip 61. As a result, the toner images are fixed on the sheet S. Note that the fixing apparatus 6 includes a fixing heater 62 for heating the toner images and the sheet S. The fixing heater 62 is, for example, a halogen heater, a ceramic heater, or the like.

As shown in FIG. 1, a switch guide 33 is a flap-like guide member that is provided downstream relative to the fixing apparatus 6 in the conveyance direction of the sheet S. Upon selection of a single-sided printing mode that forms an image on one side of the sheet S, the switch guide 33 directs the sheet S to a discharge roller 34. Upon selection of a double-sided printing mode that forms an image on both sides of the sheet S, the switch guide 33 directs the sheet S whose first side has an image formed thereon to a switch-back roller pair 35. The switch-back roller pair 35 conveys the sheet S in a predetermined direction. In a state where a trailing edge of the sheet S can enter a double-sided printing conveyance path 36, the switch-back roller pair 35 starts to rotate in reverse. As a result, the sheet S is conveyed to the double-sided printing conveyance path 36. The double-sided printing conveyance path 36 conveys the sheet S to the secondary transfer unit again. In this way, an image is formed on a second side of the sheet S.

The discharge roller 34 conveys the sheet S to the intermediate conveyance unit 120. The intermediate conveyance unit 120 includes conveyance roller pairs 121 and 122. The conveyance roller pairs 121 and 122 convey the sheet S to the post-processing apparatus 130.

### 2. Post-Processing Apparatus

The post-processing apparatus 130 is a floor-standing sheet processing apparatus. The post-processing apparatus 130 includes a mechanism that buffers a plurality of sheets, a mechanism that aligns a plurality of sheets, and a mechanism that bonds together (applies thermocompression bonding to) a bundle of sheets.

Hereinafter, an edge portion of the sheet S at the front side in the conveyance direction will be referred to as a leading edge. An edge portion of the sheet S at the rear side in the conveyance direction will be referred to as a trailing edge. Among the two edge portions of the sheet S, an edge portion that enters the post-processing apparatus 130 first will be referred to as a first edge. Among the two edge portions of the sheet S, an edge portion that enters the post-processing apparatus 130 later will be referred to as a second edge. Note that there are times when the leading edge is changed from the first edge to the second edge, and the trailing edge is changed from the second edge to the first edge, due to a switch-back conveyance executed by the post-processing apparatus 130.

The sheet S conveyed from the intermediate conveyance unit 120 is passed to an entrance roller 21 of the post-processing apparatus 130. A sheet sensor 27 called an entrance sensor is arranged downstream relative to the entrance roller 21. When the sheet sensor 27 has detected the trailing edge of the sheet S, a conveyance roller pair 22 accelerates the sheet S. When the trailing edge of the sheet S for which an upper tray 25 is set as a discharge destination has arrived between the conveyance roller pair 22 and a conveyance roller pair 24, the conveyance roller pair 22 decelerates. As a result, the conveyance speed of the sheet S becomes a predetermined discharge speed. The conveyance roller pair 24 discharges the sheet S to the upper tray 25.

When the trailing edge of the sheet S for which a lower tray 37 has been set as a discharge destination has gone past a reversal prevention valve 23, the conveyance roller pair 24 stops the conveyance of the sheet S. Thereafter, the conveyance roller pair 24 starts to rotate in reverse. As a result, the sheet S is switched back, and conveyed to a conveyance roller pair 26. When a sheet sensor 60 that is provided downstream relative to the conveyance roller pair 26 has detected the leading edge of the sheet S, the two rollers composing the conveyance roller pair 24 become separated from each other. This enables the conveyance roller pair 24 to receive a succeeding sheet S. Furthermore, the conveyance roller pair 26 stops in a state where the conveyance roller pair 26 is holding the preceding sheet S therebetween. The conveyance roller pair 26 starts to rotate in reverse in harmony with the arrival of the succeeding sheet S. Consequently, the succeeding sheet S is layered on the preceding sheet S. The conveyance roller pair 26 repeatedly switches back sheets S; as a result, the plurality of sheets S are layered, and a bundle of sheets is formed. Such an operation of forming a bundle of sheets may be referred to as a buffer operation. A unit that realizes the buffer operation is referred to as a buffer unit 80. Note that it is not essential for the buffer unit 80 to form a bundle of sheets. For example, the buffer unit 80 may switch back sheets S that have arrived from the image forming apparatus 100, and convey the sheets S in an intermediate stacking unit 42. In this case, a bundle of sheets is formed in the intermediate stacking unit 42.

When the bundle of sheets has been completed in the buffer unit 80, the conveyance roller pair 26 conveys the bundle of sheets toward the intermediate stacking unit 42. The bundle of sheets passes through a conveyance roller pair 28 and a sheet sensor 50. Furthermore, the bundle of sheets is conveyed to the intermediate stacking unit 42 by a propelling roller pair 29. In the most downstream part of the intermediate stacking unit 42, a movable vertical alignment plate 39 is arranged at a standby position. The bundle of sheets abuts on the vertical alignment plate 39; as a result, the bundle of sheets is aligned.

A plurality of bundle of sheets are stacked in order in the intermediate stacking unit 42. Note that the bundle of sheets that is conveyed to the intermediate stacking unit 42 first will be referred to as the first bundle of sheets. The bundle of sheets that arrives at the intermediate stacking unit 42 i^{th} will be referred to as the i^{th} bundle of sheets. The bundle of sheets that arrives at the intermediate stacking unit 42 last will be referred to as the N^{th} bundle of sheets. Consequently, a predetermined number of sheets S that form a booklet are stacked in the intermediate stacking unit 42. When the alignment of the predetermined number of sheets S has finished, a thermocompression bonding unit 51 executes a binding operation (thermocompression bonding processing), thereby forming a booklet. The thermocompression bonding processing may be executed repeatedly each time a bundle of sheets arrives at the intermediate stacking unit 42. As the vertical alignment plate 39 moves from the standby position to a discharge position, the booklet is pushed out toward discharge rollers 38. When the leading edge of the booklet is held between the discharge rollers 38, the vertical alignment plate 39 stops, and then returns to the standby position again. The discharge rollers 38 discharge the booklet that has been received from the vertical alignment plate 39 to the lower tray 37 via a discharge outlet 46.

In the foregoing description, the post-processing apparatus 130 forms a bundle of sheets composed of a plurality of sheets S with use of the buffer unit 80, and conveys the bundle of sheets to the intermediate stacking unit 42. However, one sheet S may be conveyed to the intermediate stacking unit 42.

### 3. Print Area of Toner Tn for Bonding

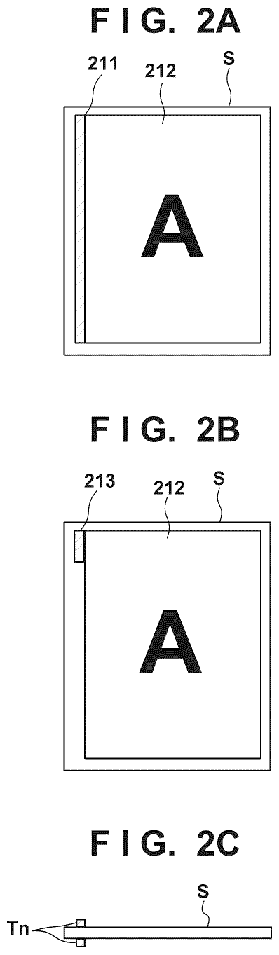

FIG. 2A shows a print area 211 of the toner Tn for bonding. The print area 211 is an adhesive area secured as a binding margin of a sheet S. In this example, the print area 211 extends parallel to a long edge of the sheet S. The print area 211 is provided in a left edge portion or a right edge portion near the long edge. In a booklet bound on the right, the print area 211 is arranged at the right edge of the sheet S. In a booklet bound on the left, the print area 211 is arranged at the left edge of the sheet S. The print area 211 may be provided in an upper edge portion or a lower edge portion near a short edge. The post-processing apparatus 130 layers a plurality of sheets S, and executes heating processing and pressing processing with respect to the print areas 211 of the plurality of sheets S; as a result, the plurality of sheets S are bonded together, and a booklet is made. In this case, the booklet is a booklet bound at a long edge. Here, the width (the length in a short-edge direction) of a toner image for bonding (the print area 211) is, for example, 4.0 mm. For example, the amount of (the amount of application of) the toner Tn for bonding per unit area may be 0.4 mg/cm². A print area 212 is an area in which a user image is printed.

As shown in FIG. 2B, a small print area 213 for the toner Tn for bonding may be formed near a corner of a sheet S. In this way, a booklet bound at a corner is made. An image based on the toner Tn for bonding is not formed on a sheet S that is a cover of a booklet. In a booklet bound on the right, the print area 213 is arranged on the upper right of the sheet S. In a booklet bound on the left, the print area 213 is arranged on the upper left of the sheet S.

The print areas 211 and 213 of the toner Tn for bonding may be formed on both sides of the sheet S as shown in FIG. 2C, or may be formed only on one side of the sheet S. Whether the print areas 211 and 213 of the toner Tn for bonding are formed only on one side or formed on both sides can be selected in consideration of, for example, the bonding performance of the post-processing apparatus 130, the bonding performance of the toner Tn for bonding, the type of sheets S, the intended use desired for a booklet, and the like. A booklet that is handled as a preserved version requires a reliable adhesion property. A reliable adhesion property is required also in a case where thick paper or a particular kind of sheet S is used as a cover of a booklet. Therefore, in such cases, the print area 211 of the toner Tn for bonding is provided on both sides of the sheet S. In a case where a booklet for simple primary use is to be made, the print area 211 of the toner Tn for bonding may be formed only on one side of the sheet S.

When the toner Tn for bonding has been applied to both sides of sheets S, the toner Tn for bonding formed on the front side of one sheet S and the toner Tn for bonding formed on the back side of another sheet come into contact with and are bonded to each other. Note that although the toner Tn for bonding is applied to the back side of the front cover and the front side of the back cover in a booklet, the toner Tn for bonding is not applied to the front side of the front cover and the back side of the back cover.

### 4. Booklet Making Operation

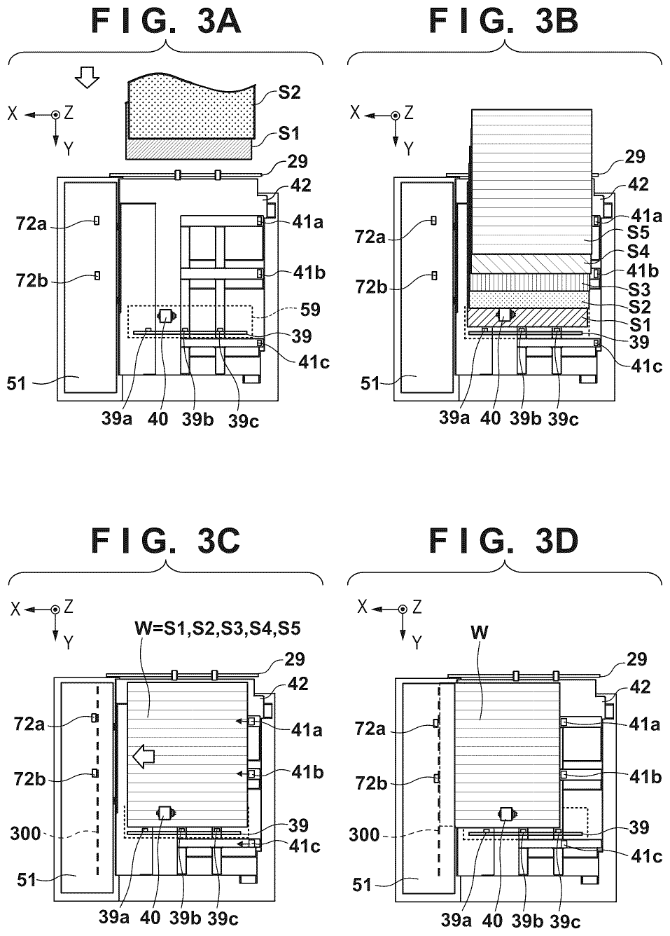

FIG. 3A to FIG. 3D show a booklet making operation executed by the intermediate stacking unit 42. An initial state is a state where the intermediate stacking unit 42 is empty. As an example, a bundle of sheets W composed of five sheets S1 to S5 is conveyed from the buffer unit 80 to the intermediate stacking unit 42. The intermediate stacking unit 42 functions as a supporting member or a holding member that support the five sheets S1 to S5.

A Y direction is a direction which is parallel to a stacking surface (a stacking plate) for the sheets S in the intermediate stacking unit 42, and which is also parallel to the conveyance direction of the sheets S conveyed from the propelling roller pair 29 to the intermediate stacking unit 42. The Y direction may be referred to as a vertical direction. An X direction is a direction which is parallel to the stacking surface for the sheets S in the intermediate stacking unit 42, and which is also perpendicular to the Y direction. The X direction may be referred to as a horizontal direction. A Z direction is a direction perpendicular to the X direction and the Y direction (a direction of a normal to the stacking surface, and a thickness direction of the stacked sheets S). The Z direction may be referred to as a height direction. Regarding the X direction, the Y direction, and the Z direction, their opposite directions may be referred to as a −X direction, a −Y direction, and a −Z direction, respectively.

The vertical alignment plate 39 and an alignment roller 40 function as a first alignment unit that aligns the plurality of sheets S in a first direction (the Y direction). The vertical alignment plate 39 is arranged in the most downstream part of the intermediate stacking unit 42 in the Y direction. The vertical alignment plate 39 is a reference member (a first reference member) that serves as a reference for a sheet position in the Y direction. The alignment roller 40 is a conveyance member that conveys the sheets S in the Y direction to align the sheets S by causing the sheets S to abut on the vertical alignment plate 39. The vertical alignment plate 39 includes a plurality of contact units 39a to 39c that are arranged at an interval in the X direction. The contact units 39a to 39c may be referred to as vertical reference plates. The plurality of contact units 39a to 39c come into contact with edge portions of the sheets S. Note that the vertical alignment plate 39 and the alignment roller 40 are configured in an integrated manner as a movable unit 59 that is movable in the Y direction. A driving source, such as a motor, enables the movable unit 59 to move in the Y direction. That is to say, the positions of the vertical alignment plate 39 and the alignment roller 40 in the Y direction can be adjusted. Horizontal alignment plates 41a to 41c of a horizontal alignment jogger 41 function as an alignment unit that align the sheets S with respect to the X direction perpendicular to the Y direction.

A driving source, such as a motor, causes the horizontal alignment plates 41a to 41c to move in the X direction, and the horizontal alignment plates 41a to 41c press side edges of the sheets S stacked in the intermediate stacking unit 42. Horizontal reference plates 72a and 72b are reference members that serve as a reference for the position of the sheets S in the X direction. The horizontal reference plates 72a and 72b are arranged so as to oppose the horizontal alignment plates 41a and 41b in the X direction.

### 4-1. Preparation Stage

As shown in FIG. 3A, the sheets S1 to S5 are conveyed toward the propelling roller pair 29. The sheets S1 to S5 may be conveyed to the intermediate stacking unit 42 in a state where a sheet Sj at a low position is protruding in the Y direction compared to a sheet Sj+1 at a high position. Here, j is an index of the sheets S. Before the sheets S are stacked in the intermediate stacking unit 42, the vertical alignment plate 39 moves to a predetermined standby position in advance in accordance with the size of the sheets S to be aligned. The standby position is set independently of the size of the sheets S so that the position of edge portions of the sheets S in the −Y direction matches a predetermined position. In other words, the standby position is a position that makes a distance from a nip position of the propelling roller pair 29 to the vertical alignment plate 39 in the Y direction slightly longer than the length of the sheets in the Y direction. The horizontal alignment plates 41a to 41c stand by at a position that is more outside in the X direction than the sheets S being conveyed, so as not to hinder the conveyance of the sheets S.

### 4-2. Vertical Alignment Stage

FIG. 3B shows that the trailing edge of the first sheet S1 has gone past the nip of the propelling roller pair 29 and the leading edge of the sheet S1 has reached the alignment roller 40. The sheet S1 abuts on the vertical alignment plate 39, and is aligned while the position of the vertical alignment plate 39 is used as a reference. Continuous rotation of the alignment roller 40 causes the sheets S2 to S5, which reach the alignment roller 40 subsequent to the sheet S1, to abut on the vertical alignment plate 39 in sequence. As a result, the five sheets S1 to S5 are aligned with respect to the Y direction (vertical direction) while the position of the vertical alignment plate 39 is used as a reference.

### 4-3. Horizontal Alignment Stage

FIG. 3C shows that, after completion of the alignment of the sheets S1 to S5 in the Y direction (vertical direction), the alignment in the X direction (horizontal direction) has been started. The horizontal alignment plates 41a to 41c are driven in the X direction, which is an alignment direction, come into contact with side edges of the sheets S1 to S5, and press the sheets S1 to S5 toward the horizontal reference plates 72a and 72b. Then, the other side edges of the sheets S1 to S5 come into contact with contact surfaces 300 of the horizontal reference plates 72a and 72b; as a result, the sheets S1 to S5 are aligned with respect to the X direction (horizontal direction) while the position of the horizontal reference plates 72a and 72b is used as a reference.

### 4-4. Bonding Stage (Thermocompression Bonding Stage)

FIG. 3D shows a state where the alignment of the five sheets S1 to S5 in the X direction and the Y direction has been completed. A target position (an alignment position) in an alignment operation is the position of the bundle of sheets W at the time of execution of bonding processing (thermocompression bonding) by the thermocompression bonding unit 51. As stated earlier, the image forming apparatus 100 applies the toner Tn for bonding to the sheets S1 to S5 so that the side at which a toner image for bonding has been formed is at the side of the thermocompression bonding unit 51. In a case where the sheet S1 is a cover of a booklet, the toner Tn for bonding may not be applied thereto.

The thermocompression bonding unit 51 applies thermocompression bonding to the sheets S1 to S5 for which the alignment has been completed. During this, the horizontal alignment plates 41a to 41c withdraw in the −X direction. This places the intermediate stacking unit 42 in a state where it can receive the next plurality of sheets S. Thereafter, a bundle of sheets W composed of sheets S6 to S10, which has been made by the buffer unit 80, is stacked on the sheets S1 to S5.

Thereafter, the above-described four stages are repeated with respect to the preceding bundle of sheets W composed of the sheets S1 to S5 that have been bonded together, and the bundle of sheets W composed of the sheets S6 to S10 that have not been bonded together. In this way, the sheets S1 to S10 are bonded together in a state where they have been aligned with high accuracy.

A bundle of sheets W is composed of five sheets S as one example. However, the number of sheets S composing a bundle of sheets W may be two or three, for example. That is to say, it is sufficient that the number of sheets S included in a bundle of sheets W be equal to or smaller than the maximum number of sheets S that can be layered in the buffer unit 80.

### 4-5. Intermediate Stacking Unit (Alignment Unit)

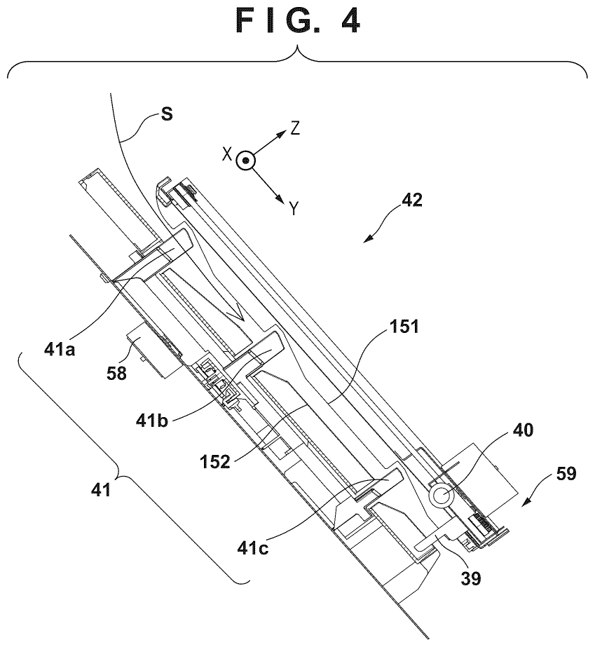

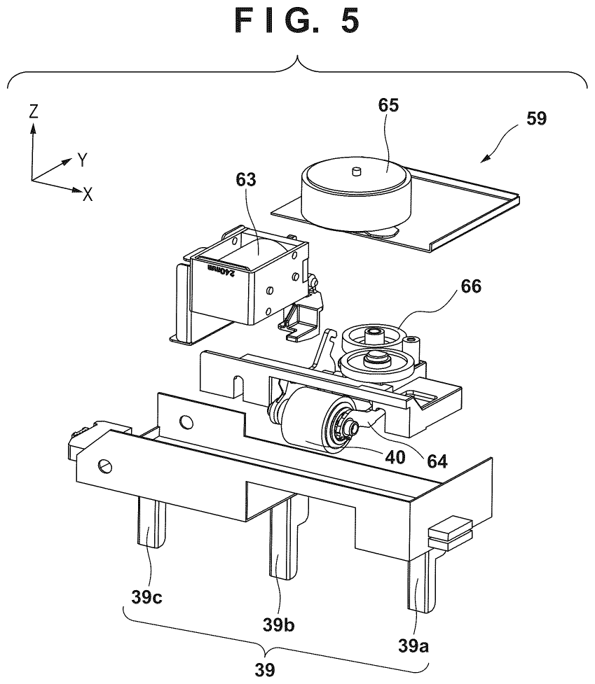

FIG. 4 is a cross-sectional diagram of the intermediate stacking unit 42. FIG. 5 is an exploded diagram of the movable unit 59. The Z direction is a direction in which a pressing unit 171 of the thermocompression bonding unit 51 approaches a reception member 180 to press a bundle of sheets. Also, the Z direction is a height direction (a thickness direction) of a bundle of sheets W stacked in the intermediate stacking unit 42. The directions that are perpendicular to each other on a virtual plane that is perpendicular to the Z direction are the X direction and the Y direction. The Y direction is substantially parallel to the conveyance direction in which the propelling roller pair 29 conveys sheets S to the intermediate stacking unit 42. The X direction is a width direction perpendicular to the conveyance direction. In the following description, the Y direction may be referred to as a “vertical direction”. The X direction may be referred to as a “width direction” or a “horizontal direction”.

The intermediate stacking unit 42 includes guides 151 and 152, and the movable unit 59. The guides 151 and 152 are arranged in parallel to the conveyance direction of sheets S or a bundle of sheets W, and direct the sheets S or the bundle of sheets W to the vertical alignment plate 39. The movable unit 59 includes the vertical alignment plate 39 and the alignment roller 40. The vertical alignment plate 39 includes a plurality of contact units 39a, 39b, and 39c that are arranged along the width direction. The contact units 39a, 39b, and 39c provide a reference position for aligning a plurality of sheets S in the conveyance direction (Y direction). The alignment roller 40 is rotatably held by a roller holder 64. The roller holder 64 oscillates due to a driving force of a solenoid 63. The oscillation of the roller holder 64 causes the alignment roller 40 to move between a contact position and a standby position. The contact position is a position at which the alignment roller 40 can come into contact with sheets S on the guide 152. The standby position is a position at which the alignment roller 40 is separated from sheets S on the guide 152. The standby position may be referred to as a home position.

A motor 65 is mounted on the movable unit 59. A driving force of the motor 65 is transmitted to the alignment roller 40 via a series of gears 66. As a result, the alignment roller 40 rotates. The movable unit 59 can move in parallel to the conveyance direction (Y direction). As the movable unit 59 moves in the −Y direction, a completed booklet is sent to the discharge rollers 38. Thereafter, as the movable unit 59 moves in the +Y direction, the movable unit 59 returns to the standby position (alignment position).

As shown in FIG. 3A and FIG. 4, the intermediate stacking unit 42 includes the horizontal alignment jogger 41, a motor 58, and the horizontal reference plates 72a and 72b. The horizontal alignment jogger 41 includes the horizontal alignment plates 41a to 41c. A driving force of the motor 58 enables the horizontal alignment jogger 41 to move in parallel to the width direction (X direction). As shown in FIG. 3A, the horizontal reference plates 72a and 72b are a plurality of plate-like members (contact units) that are arranged along the conveyance direction. The horizontal reference plates 72a and 72b serve as reference positions during the alignment of sheets S in the width direction (X direction).

### 4-6. Thermocompression Bonding Unit

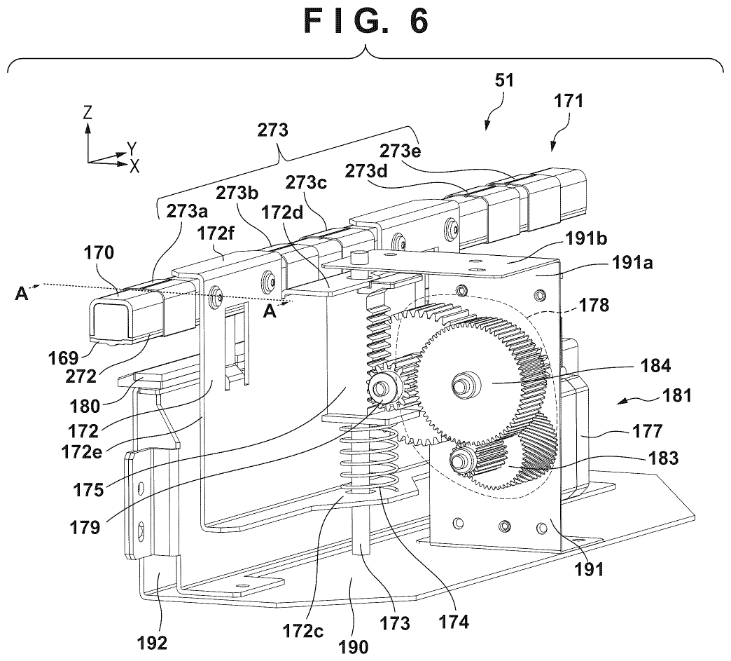

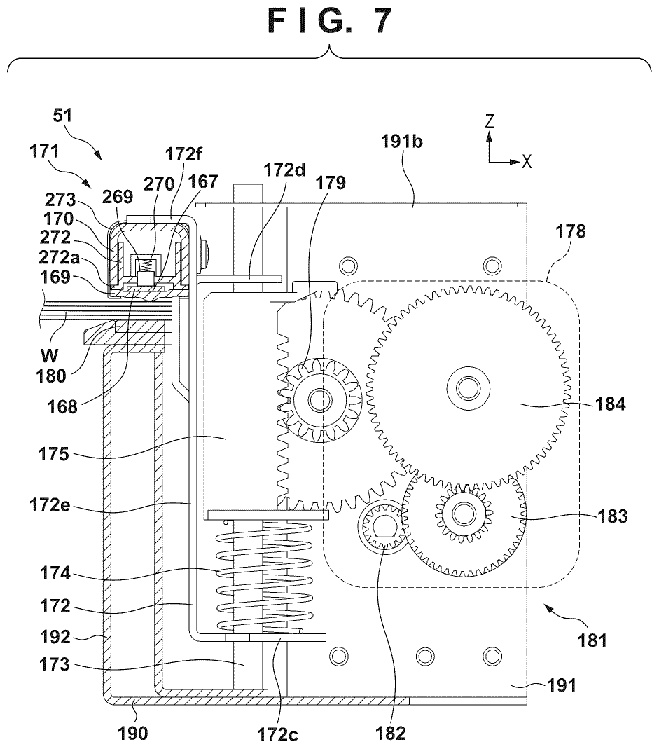

FIG. 6 is a perspective diagram showing main components of the thermocompression bonding unit 51. It shows a state where the pressing unit 171 of the thermocompression bonding unit 51 is separated from sheets S and the reception member 180. FIG. 7 is a cross-sectional diagram obtained by cutting the thermocompression bonding unit 51 along an A-A cutting line. FIG. 7 shows a state where the thermocompression bonding unit 51 is pressing a bundle of sheets W.

The thermocompression bonding unit 51 includes the pressing unit 171, the reception member 180, and a driving mechanism 181. The pressing unit 171 is a first pressing member that heats and presses the bundle of sheets W. The reception member 180 is a second pressing member which is situated to oppose the pressing unit 171, and which catches a pressing force (pushing force) from the pressing unit 171. That is to say, the bundle of sheets W is pressed and heated as a result of the pressing unit 171 and the reception member 180 holding the bundle of sheets W therebetween. The driving mechanism 181 causes the pressing unit 171 to move in the +Z direction and the −Z direction. The movement of the pressing unit 171 in the +Z direction may be referred to as an ascent (a separating operation or a returning operation) of the pressing unit 171. The movement of the pressing unit 171 in the −Z direction may be referred to as a descent (an approaching operation or a pressing operation) of the pressing unit 171.

The driving mechanism 181 includes a motor 177, a series of gears 178, a pinion gear 179, and a rack gear 175. The series of gears 178 transmits a driving force (rotation force) generated by the motor 177 to the pinion gear 179. The series of gears 178 includes a motor gear 182 and double gears 183 and 184. The motor gear 182 meshes with main teeth of the double gear 183, and transmits the rotation force of the motor 177 to the double gear 183. Sub teeth of the double gear 183 mesh with main teeth of the double gear 184. Sub teeth of the double gear 184 mesh with main teeth of the pinion gear 179. Sub teeth of the pinion gear 179 mesh with the rack gear 175. In this way, the pinion gear 179 meshes with the rack gear 175, and converts the rotation force into a force in the Z direction. The rack gear 175 is guided by a cylindrical guide shaft 173 extending in the Z direction, and is held slidably in the Z direction. The guide shaft 173 is fixed to a frame 190 of the thermocompression bonding unit 51. A gear supporting member 191 is fixed to the frame 190. The gear supporting member 191 includes a supporting surface 191a parallel to a ZX plane, and a supporting surface 191b parallel to an XY plane. The supporting surface 191a has a plurality of holes, and an output shaft of the motor 177, rotation shafts of the series of gears 178, and a rotation shaft of the pinion gear 179 are inserted through the respective holes. The series of gears 178 and the pinion gear 179 are rotatably supported by the supporting surface 191a. The supporting surface 191b supports an upper end of the guide shaft 173. The frame 190 supports a lower end of the guide shaft 173.

The frame 190 includes a supporting panel 192 that supports the reception member 180. The supporting panel 192 is arranged substantially in parallel to a ZY plane. In this example, the supporting panel 192 is formed by bending an end portion of the frame 190.

A lift plate 172 includes a first upper surface plate 172d, a second upper surface plate 172f, a lower surface plate 172c, and a supporting plate 172e. The first upper surface plate 172d, the second upper surface plate 172f, and the lower surface plate 172c extend in parallel to an XY plane. The first upper surface plate 172d extends in the +X direction from the vicinity of an upper end of the supporting plate 172e. The second upper surface plate 172f extends in the −X direction from the upper end of the supporting plate 172e. The second upper surface plate 172f supports the pressing unit 171. Note that according to FIG. 6, the lift plate 172 has four screw holes provided in the supporting plate 172e. The lift plate 172 is fastened to the pressing unit 171 by four screws inserted through the four screw holes.

The lower surface plate 172c extends in the +X direction from a lower end of the supporting plate 172e. The lift plate 172 is held slidably in the Z direction along the guide shaft 173. A spring 174 is arranged between the rack gear 175 and the lower surface plate 172c of the lift plate 172. The spring 174 generates a pressing force (pushing force) for pressing a pressing plate 169 against the bundle of sheets W. The spring 174 may be referred to as a compression spring or a pressing spring. The pressing plate 169 may be referred to as a heat transfer plate.

In a case where the pressing unit 171 is separated from the reception member 180, the rack gear 175 is pushed upward by the spring 174. As a result, the rack gear 175 abuts on the first upper surface plate 172d of the lift plate 172. When the pressing unit 171 is pressing the bundle of sheets W, the rack gear 175 is driven by the pinion gear 179 and thus becomes separated from the first upper surface plate 172d of the lift plate 172. Furthermore, as the rack gear 175 descends, the spring 174 descends as well, and the spring 174 pushes down the lower surface plate 172c. As the lower surface plate 172c descends, the lift plate 172 descends, and the pressing unit 171 descends as well. In this way, the existence of the spring 174 makes it possible to apply an appropriate pressing force to the bundle of sheets W of an arbitrary thickness.

As the pressing unit 171 is fixed to the lift plate 172, the pressing unit 171 slides in the Z direction integrally with the lift plate 172. The pressing unit 171 includes a ceramic heater 168, a metallic stay 170, a thermistor holder 272, and the pressing plate 169.

The ceramic heater 168 includes a heater substrate and a resistance heating element pattern formed on the heater substrate. The thermistor holder 272 is formed of highly thermostable resin, and holds thermistors 269. The thermistors 269 are temperature sensors that detect the temperature of the ceramic heater 168 via the thermistor holder 272. A spring 270 pushes the thermistors 269 against the thermistor holder 272. This enables the thermistors 269 to accurately detect the temperature of the ceramic heater 168.

The pressing plate 169 may be a metallic plate made of aluminum. A first surface of the pressing plate 169 may have a projecting shape that protrudes in the −Z direction to press the bundle of sheets W. A second surface of the pressing plate 169 is a flat surface along a heating surface of the ceramic heater 168. The heat of the ceramic heater 168 maintains the pressing plate 169 at a predetermined temperature.

Fine recesses and projections exist on each of the surfaces of the ceramic heater 168 and the surfaces of the pressing plate 169, and they lower the thermal conduction efficiency. In view of this, a viscous or elastic heat transfer material layer 167 may be arranged in a contact boundary portion between the ceramic heater 168 and the pressing plate 169.

As shown in FIG. 7, the pushing force of the spring 174 is transmitted to the bundle of sheets W via the lift plate 172, the metallic stay 170, a flange 272a of the thermistor holder 272, and the pressing plate 169. The ceramic heater 168 is fixed to the second surface of the pressing plate 169 that does not receive the pushing force of the spring 174. Therefore, an impact force from the spring 174 is not likely to be propagated to the ceramic heater 168.

Although the spring 174 is arranged so as to press the pressing unit 171 in the first embodiment, this is merely an example. The spring 174 may be arranged underneath the reception member 180. In this case, the spring 174 pushes the reception member 180 against the pressing unit 171. Also, the spring 174 may be provided for each of the pressing unit 171 and the reception member 180.

The heat of the pressing plate 169 is propagated not only to the bundle of sheets W, but also to the thermistor holder 272 and the metallic stay 170. For this reason, the flange 272a of the thermistor holder 272 intervenes on a transmission path via which the pushing force of the spring 174 is transmitted. That is to say, out of the thermistor holder 272, only the flange 272a is held between the pressing plate 169 and the metallic stay 170, and positioning thereof is carried out in an internal space of the pressing unit 171. The thermal conductivity of the thermistor holder 272 is lower than the thermal conductivity of the metallic stay 170. The flange 272a inhibits or reduces the heat propagation from the pressing plate 169 to the metallic stay 170. Therefore, the heat of the pressing plate 169 is easily propagated to the bundle of sheets W. The material of the thermistor holder 272 is, for example, resin.

The metallic stay 170, the thermistor holder 272, and the pressing plate 169 that form the pressing unit 171 are integrally held by a group of clips 273. The group of clips 273 includes a clip 273a, a clip 273b, a clip 273c, a clip 273d, and a clip 273e.

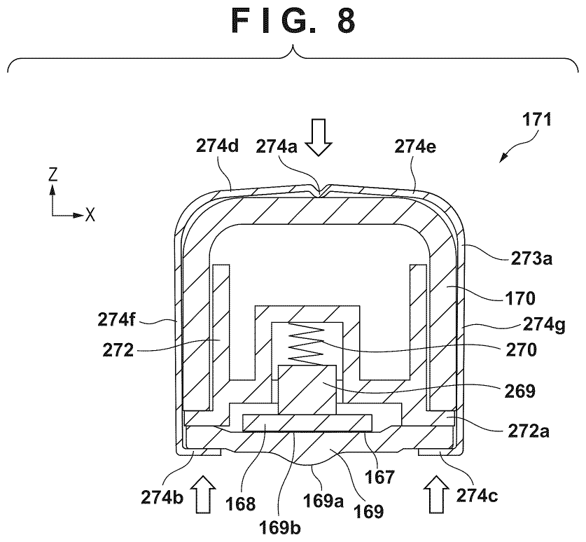

FIG. 8 is a cross-sectional diagram of the pressing unit 171 taken along the A-A cross-section line shown in FIG. 6. The ceramic heater 168 exists substantially throughout the entire pressing unit 171 in the Y direction. Three thermistors 269 are provided for the ceramic heater 168. The three thermistors 269 are arranged at an equal interval in the Y direction. For example, the first thermistor 269 is arranged near the clip 273a. The second thermistor 269 is arranged near the clip 273c at the center. The third thermistor 269 is arranged near the clip 273e. The structures around these three thermistors 269 are the same.

The spring 270 pushes the thermistors 269 against the ceramic heater 168. The spring 270 pushes the ceramic heater 168 against the second surface 169b of the pressing plate 169 via the thermistors 269. The spring 270 may be arranged so as to push the ceramic heater 168 directly against the pressing plate 169. Three or more springs 270 may be provided.

The group of clips 273 is a fixing device made of metal, such as stainless steel (SUS). As shown in FIG. 6, the clips 273a to 273e may have the same shape. The clips 273a to 273e are arranged at different positions in the Y direction. The arrangement of the group of clips 273 is decided in view of areas that are easily influenced by local pressing in a longitudinal direction. Such areas are areas corresponding to edge sections of sheets S of standard sizes. For example, the clip 273a is arranged at a reference position of sheets S in the Y direction. The clip 273d is arranged at a position corresponding to a B5 size and an EXE size. The clip 273e is arranged at a position corresponding to an A4 size and a LTR size.

The clip 273a is used as a representative of the group of clips 273 to describe a method of fixing and supporting the pressing unit 171 with use of the group of clips 273. The shape of the clip 273a in a ZX cross-section is substantially a U shape. The clip 273a includes support units 274a to 274g. The support unit 274a exists at the center of the clip 273a, protrudes in the −Z direction, and is in contact with the metallic stay 170. Each of the support units 274d and 274e forms a U-shaped bottom surface, and is in contact with the metallic stay 170. The support units 274f and 274g extend in parallel with a YZ plane. The support unit 274d and the support unit 274b are joined by the support unit 274f. The support unit 274e and the support unit 274c are joined by the support unit 274g. The support units 274b and 274c each extend in parallel to an XY plane, and support one end and the other end of the first surface 169a of the pressing plate 169, respectively.

As shown in FIG. 8, the support units 274d and 274e are attached to the metallic stay 170 in a warped state. As a result, the support units 274a, 274d, and 274e push the metallic stay 170 in the −Z direction. The support units 274b and 274c push the pressing plate 169 in the +Z direction. That is to say, due to their pushing forces, the pressing plate 169, the thermistor holder 272, and the metallic stay 170 are integrally held.

The clips 273a to 273e maintain the mutual distances among the pressing plate 169, the thermistor holder 272, and the metallic stay 170 in the Z direction constant. Note that the clips 273a to 273e allow the thermistor holder 272 and the metallic stay 170 to move in the X direction and the Y direction. When the ceramic heater 168 has generated heat, this heat causes the pressing plate 169, the thermistor holder 272, the metallic stay 170, and the like to expand. The coefficient of thermal expansion of the pressing plate 169, the coefficient of thermal expansion of the thermistor holder 272, and the coefficient of thermal expansion of the metallic stay 170 may be different from one another. In view of this, the clips 273a to 273e allow the pressing plate 169, the thermistor holder 272, and the metallic stay 170 to slide in the X direction and the Y direction in order to absorb the differences in the coefficient of thermal expansion.

### 5. Thermocompression Bonding Processing

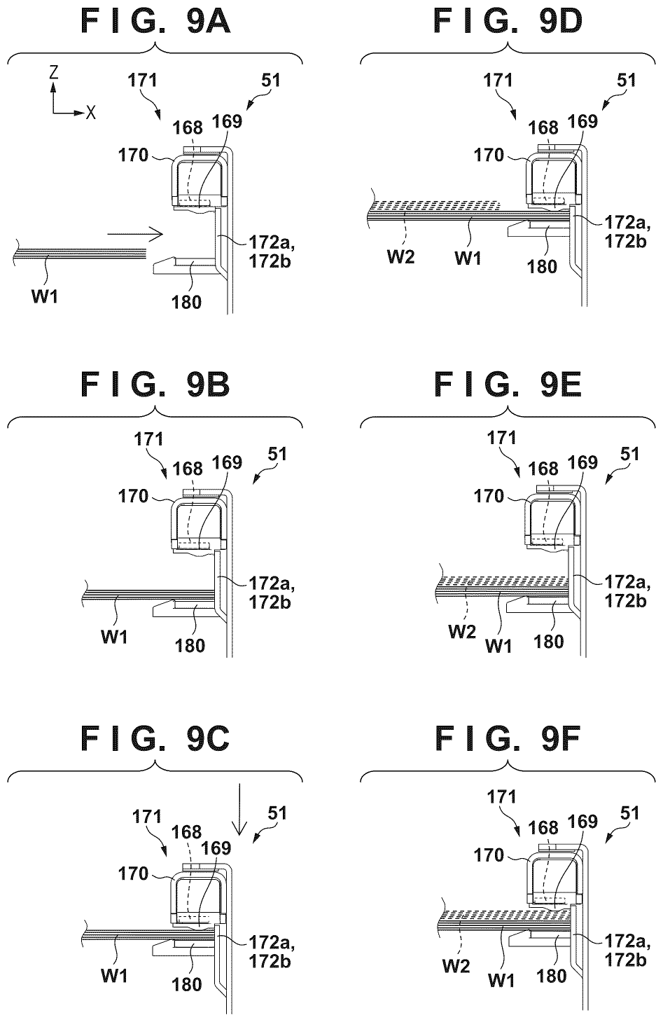

FIG. 9A to FIG. 9F are diagrams of the thermocompression bonding unit 51 as viewed from the conveyance direction (Y direction).

FIG. 9A (reception phase): The pressing unit 171 is separated from the reception member 180, and is located at the home position. A bundle of sheets W1 composed of sheets S1 to S5 have been aligned in the Y direction. The horizontal alignment jogger 41 causes the bundle of sheets W1 to move in the X direction.

FIG. 9B (horizontal alignment phase): The horizontal alignment jogger 41 causes the bundle of sheets W1 to abut on the horizontal reference plates 72a and 72b. This causes the bundle of sheets W1 to be aligned also in the X direction. Note that the pressing unit 171 is still located at the home position.

FIG. 9C (thermocompression bonding phase): The motor 177 rotates in a forward direction, and the pressing unit 171 consequently moves in the −Z direction. The pressing plate 169 comes into contact with the sheet S5 that is located at the top among the bundle of sheets W1. As a result, pressure is applied to adhesive layers of the bundle of sheets W1. Furthermore, the heat generated by the ceramic heater 168 heats the adhesive layers of the bundle of sheets W1 via the pressing plate 169. The toner Tn for bonding included in the adhesive layers is melted, thereby bonding together two neighboring sheets S.

FIG. 9D (reception phase): During thermocompression bonding of the bundle of sheets W1 by the pressing plate 169, the next bundle of sheets W2 is conveyed by the horizontal alignment jogger 41 in the X direction. The bundle of sheets W2 is composed of sheets S6 to S10. The bundle of sheets W2 is stacked on the sheets S1 to S5.

FIG. 9E (horizontal alignment phase): Upon completion of thermocompression bonding of the bundle of sheets W1, the motor 177 rotates in a reverse direction, and the pressing unit 171 moves in the Z direction. As a result, the pressing unit 171 is separated from the bundle of sheets W1 and the reception member 180. Thereafter, the horizontal alignment jogger 41 causes the bundle of sheets W2 to move in the X direction, and causes the bundle of sheets W2 to come into contact with the horizontal reference plates 72a and 72b. This causes the sheets S6 to S10 included in the bundle of sheets W2 to be aligned in the X direction.

FIG. 9F (thermocompression bonding phase): The motor 177 rotates in the forward direction, and the pressing unit 171 consequently moves in the −Z direction. The pressing plate 169 comes into contact with the bundle of sheets W2, and further presses the bundle of sheets W2. As a result, pressure is applied to adhesive layers of the bundle of sheets W2. Furthermore, the heat generated by the ceramic heater 168 heats the adhesive layers of the bundle of sheets W2 via the pressing plate 169. The toner Tn for bonding included in the adhesive layers is melted, thereby bonding together two neighboring sheets S. Note that the toner Tn for bonding has been applied also to the lower side of the sheet S6 that is located at the bottom among the bundle of sheets W2. As a result, the sheet S5 in the bundle of sheets W1 and the sheet S6 in the bundle of sheets W2 also undergo thermocompression bonding. That is to say, all of the sheets S1 to S10 undergo thermocompression bonding, and one booklet is completed. Note that a booklet composed of a larger number of sheets S may be made by further performing thermocompression bonding repeatedly with respect to many bundles of sheets W.

When every thermocompression bonding has finished, the vertical alignment plate 39 moves in the −Y direction. The vertical alignment plate 39 comes into contact with a trailing edge of the booklet, and pushes out the booklet in the −Y direction. As a result, the booklet is passed to the discharge rollers 38. The discharge rollers 38 discharge the booklet to the lower tray 37. Thereafter, the vertical alignment plate 39 returns to the standby position.

### 6. Summary

According to the first embodiment, the pushing force of the spring 174 is transmitted to a bundle of sheets W via the lift plate 172, the metallic stay 170, the flange 272a of the thermistor holder 272, and the pressing plate 169. Therefore, the pushing force of the spring 174 is not transmitted to the ceramic heater 168. The pushing force to which the ceramic heater 168 is subjected is the pushing force of the spring 270. Here, the pushing force of the spring 270 is smaller than the pushing force of the spring 174.

Therefore, even if the pressing unit 171 repeats the approaching operation and the separating operation with respect to sheets S, a strong pushing force is not repeatedly applied to the ceramic heater 168. Therefore, a product life of the ceramic heater 168 is improved, and a product life of a booklet making apparatus is also improved.

### 7. Exemplary Modification

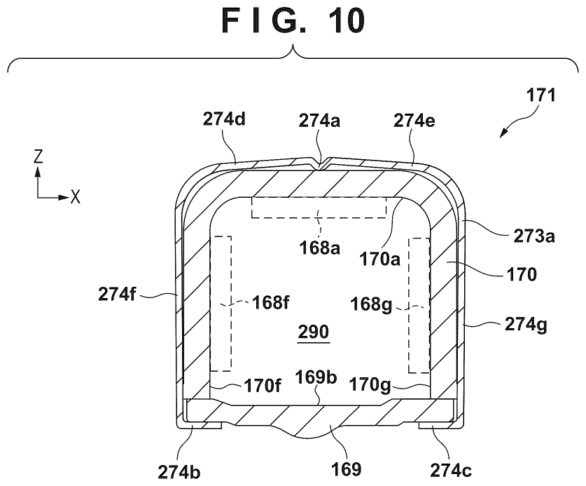

FIG. 10 is a diagram for describing a reduction in a pushing force on the ceramic heater 168 in the first embodiment and an exemplary modification thereof. It is sufficient that the ceramic heater 168 be arranged at a position at which it is capable of heating the pressing plate 169, and which does not receive the pressing force of the spring 174. The position that does not receive the pressing force is a position that is distanced from a transmission path of the pressing force. According to FIG. 10, ceramic heaters 168 are provided in an internal space 290 that is provided inside the pressing unit 171. The internal space 290 is a space enclosed by side walls 170f and 170g, a ceiling 170a, and the second surface 169b of the pressing plate 169. The pressing force supplied from the spring 174 via the lift plate 172 is propagated to a pressing surface (first surface 169a) of the pressing plate 169 via the ceiling 170a and the side walls 170f and 170g of the internal space 290. Therefore, the ceramic heaters 168 are arranged at positions that are distanced from a transmission path of the pressing force.

According to FIG. 8, the ceramic heater 168 is fixed to, or pushed against, the surface (second surface 169b) that intersects with the side walls 170f and 170g of the internal space 290. The thermistor holder 272 is provided in the internal space 290, and holds the ceramic heater 168 together with the thermistors 269. The pressing unit 171 includes the pressing plate 169 that is arranged so as to oppose the reception member 180. The first surface 169a of the pressing plate 169 is a pressing surface that presses a bundle of sheets W. The spring 270 is arranged between the thermistor holder 272 and the ceramic heater 168. The spring 270 pushes the ceramic heater 168 against the second surface 169b of the pressing plate 169, which is located on the opposite side of the first surface 169a. The temperature sensors (thermistors 269) are arranged between the spring 270 and the ceramic heater 168. The ceramic heater 168 may be bonded or fastened so as to be in contact with the pressing unit 171. A viscous or elastic heat transfer material may be arranged between the ceramic heater 168 and the pressing unit 171.

The pressing unit 171 is an example of the first pressing member and the second pressing member. The reception member 180 is an example of the second pressing member and the first pressing member. This is because it is sufficient that the second pressing member be capable of holding the bundle of sheets W between itself and the first pressing member in coordination, and pressing a heat-melting adhesive layer formed between two neighboring sheets S among a plurality of sheets included in the bundle of sheets W. The driving mechanism 181 is an example of a moving unit that causes at least one of the first pressing member and the second pressing member to move. This realizes the approaching operation for generating a pressing force between the first pressing member and the second pressing member by causing the first pressing member and the second pressing member to approach each other, and the separating operation for cancelling the pressing force by causing the first pressing member and the second pressing member to be separated from each other. The ceramic heater 168, which heats the pressing unit 171, may be arranged in the reception member 180. In this case, too, the ceramic heater 168 is arranged at a position to which the pressing force is not applied (e.g., an internal space or a side surface of the reception member 180).

As shown in FIG. 8 and FIG. 10, the lift plate 172 is an example of a transmission member that transmits the pushing force of the spring 174 to at least one of the pressing unit 171 and the reception member 180. The driving mechanism 181 causes the spring 174 to generate a pushing force by compressing or extending the spring 174. This pushing force acts as a pressing force.

The pressing unit 171 includes the metallic stay 170, the pressing plate 169, and the thermistor holder 272. The metallic stay 170 has a first thermal conductivity. The pressing plate 169 has a second thermal conductivity, and is supported by the metallic stay 170. The internal space 290 is formed by the metallic stay 170 and the pressing plate 169. The thermistor holder 272 holds the ceramic heater 168 in the internal space 290. The thermal conductivity of the thermistor holder 272 may be lower than the first thermal conductivity and the second thermal conductivity. The group of clips 273 is an example of a fixing device that fixes the pressing plate 169 relative to the metallic stay 170. The clips 273a to 273e are examples of a plurality of clips that are mounted on an exterior of a part of the metallic stay 170 and the pressing plate 169. As shown in FIG. 6, the plurality of clips 273a to 273e may be arranged at different positions in a longitudinal direction of the pressing unit 171 (the Y direction). The clips 273a and 273d are examples of a first clip and a second clip that are arranged in correspondence with a first standard size. The clips 273a and 273e are examples of a first clip and a third clip that are arranged in correspondence with a second standard size. The clip 273c is an example of a fourth clip that is arranged at the center in the longitudinal direction of the pressing unit 171.

According to FIG. 8, the pressing plate 169 includes the first surface 169a on which the pressing force of the spring 174 acts, and the second surface 169b on which the pressing force does not act. The ceramic heater 168 may be fixed to the second surface 169b. On the other hand, as shown in FIG. 10, ceramic heaters 168 may be fixed to surfaces that are parallel to a direction in which the pressing force is exerted (the −Z direction) in the pressing unit 171. For example, a ceramic heater 168f may be fixed to, or pushed against, the side wall 170f. A ceramic heater 168g may be fixed to, or pushed against, the side wall 170g. Note, it is sufficient that the ceramic heaters 168 be arranged at positions on which the pressing force of the spring 174 does not act, or is not likely to act. Therefore, a ceramic heater 168a may be arranged on the ceiling 170a. In this case, the heat generated from the ceramic heaters 168a, 168f, and 168g is propagated from the metallic stay 170 to the pressing plate 169. Therefore, the ceramic heaters 168a, 168f, and 68g are arranged at positions that are distanced from a transmission path of the pressing force. Although the side walls 170f and 178g are transmission paths of the pressing force, the pressing force of the spring 174 does not act on the ceramic heaters 168f and 168g. In this way, a position on which the pressing force of the spring 174 does not act is a position that is distanced from a transmission path. Therefore, the ceramic heaters 168a, 168f, and 168g may be arranged on a side surface of a transmission path of the pressing force.

The thermocompression bonding unit 51 is an example of a long thin heating and pressing unit that heats and presses adhesive layers in a state where a plurality of sheets S on which the adhesive layers have been formed are layered. The pressing plate 169 is an example of a pressing plate that comes into contact with and presses sheets S. The ceramic heater 168 is an example of a heating body that heats the pressing plate 169. The reception member 180 is an example of a reception member that opposes the pressing plate 169. The pressing unit 171, the lift plate 172, and the motor 177 represent an example of a pressing mechanism that applies pressure to sheets S held between the pressing plate 169 and the reception member 180. The post-processing apparatus 130 is an example of a booklet making apparatus that makes a booklet by heating and pressing adhesive layers formed on a plurality of sheets S while holding the plurality of sheets S on which the adhesive layers have been formed between the pressing plate 169 and the reception member 180. Here, the pressing mechanism applies pressure to a plurality of sheets 2 held between the pressing plate 169 and the reception member 180 by pressing the pressing plate 169 without applying a force to the ceramic heater 168.

Each of the pressing plate 169 and the ceramic heater 168 may have a long thin shape. There is a first direction (e.g., the X direction) that is perpendicular to each of a longitudinal direction of the pressing plate 169 (e.g., the Y direction) and a direction in which the pressing plate 169 and the reception member 180 oppose each other (e.g., the Z direction). As exemplarily shown in FIG. 7, the pressing plate 169 is longer than the ceramic heater 168 in the first direction. As exemplarily shown in FIG. 8, the pressing mechanism presses areas in the first direction of the pressing plate 169 that do not overlap the ceramic heater 168. Pressure may be applied to sheets S held between the pressing plate 169 and the reception member 180 in this way. As exemplarily shown in FIG. 8, the ceramic heater 168 may be in contact with the pressing plate 169.

### Second Embodiment

A second embodiment is an exemplary modification of the first embodiment. In the second embodiment, a heater is coupled to a pressing plate using an adhesive instead of the spring 270 of the first embodiment. The pressing plate is fixed to a lift plate using an adhesive instead of the group of clips 273. Regarding a part of the disclosure of the second embodiment that is the same as the disclosure of the first embodiment, the description of the first embodiment is incorporated.

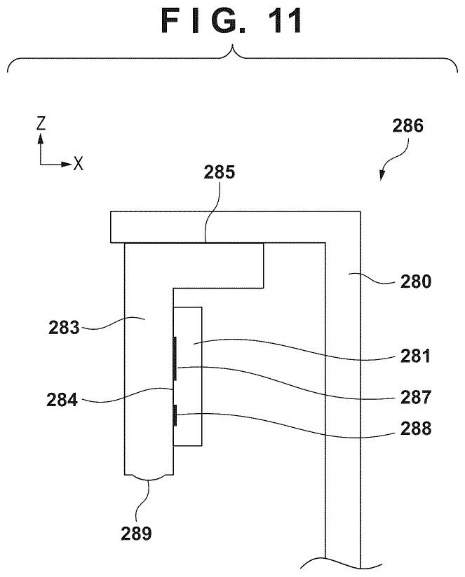

FIG. 11 is a cross-sectional diagram for describing the second embodiment. The pressing unit 171 of the first embodiment is replaced with a pressing unit 286. In FIG. 11, the pressing unit 286 is cut along a cross-section parallel to a ZX plane. The shape of a lift plate 280 is substantially the same as, or similar to, the shape of the lift plate 172.

A pressing plate 283 is an L-shaped metallic block. The material of the pressing plate 283 is, for example, copper metal. The thickness of the pressing plate 283 is, for example, 3 mm. A pressing surface 289 comes into contact with a bundle of sheets W, and heats and presses the bundle of sheets W. The pressing plate 283 is bonded to the lift plate 280 using a thermostable silicone adhesive 285. In this way, the heat is not likely to be propagated from the pressing plate 283 to the lift plate 280.

A ceramic heater 281 includes a substrate with a high thermal conduction property. The thickness of this substrate is, for example, 1 mm. The material of the substrate is, for example, alumina. A heat generator pattern 287 and a printing thermistor 288 are formed on the substrate of the ceramic heater 281. The ceramic heater 281 is bonded to the pressing plate 283 using a thermostable silicone adhesive 284.

According to the second embodiment, the metallic stay 170 and the thermistor holder 272 are not used. That is to say, the pushing force of the spring 174 is transmitted to the bundle of sheets W via the lift plate 280 and the pressing plate 283.

As described above, the ceramic heater 281 is arranged at a position at which it is capable of heating the pressing plate 283, and which is distanced from a transmission path of the pressing force generated by the spring 174. In this way, a product life of the ceramic heater 281 is improved, and a product life of a booklet making apparatus is also improved.

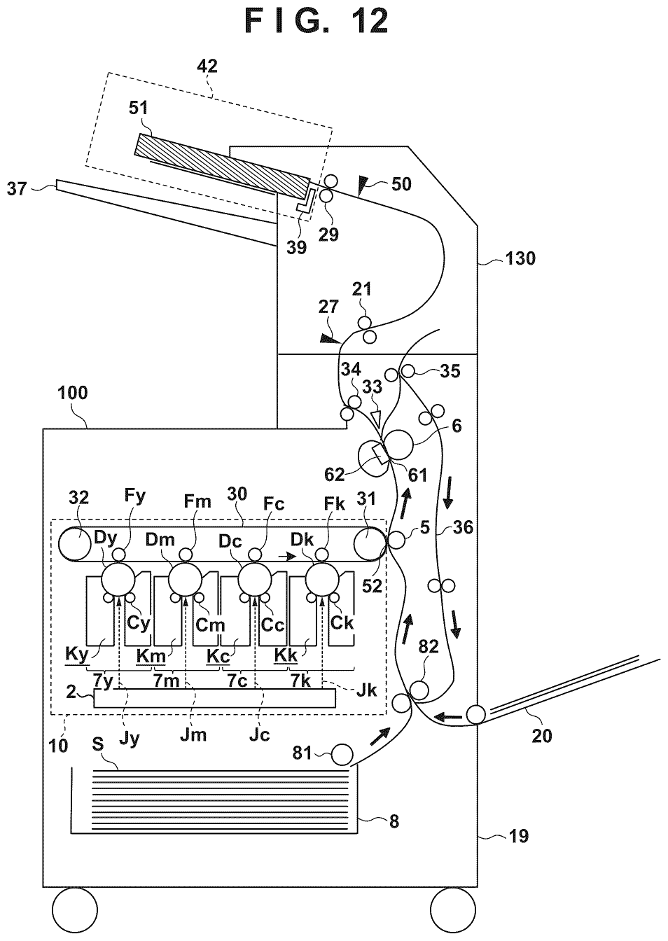

In FIG. 1, although the post-processing apparatus 130 that includes the thermocompression bonding unit 51 is arranged next to the image forming apparatus 100, this is merely an example. As shown in FIG. 12, the post-processing apparatus 130 and the thermocompression bonding unit 51 may be arranged in an upper portion of a body of the image forming apparatus 100. In this case, the discharge roller 34 passes a sheet S directly to the post-processing apparatus 130. When the sheet sensor 27 has detected the leading edge of the sheet S, the entrance roller 21 conveys the sheet S. Furthermore, the propelling roller pair 29 conveys the sheet S to the intermediate stacking unit 42. Note that the direction in which the sheet S is carried into the intermediate stacking unit 42 in FIG. 12 is opposite to the direction in which the sheet S is carried into the intermediate stacking unit 42 in FIG. 1.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-159414, filed Sep. 13, 2024, which is hereby incorporated by reference herein in its entirety.

What is claimed is:

1. A booklet making apparatus, comprising
a long thin heating and pressing unit that heats and presses an adhesive layer in a state where a plurality of sheets on which the adhesive layer has been formed are layered,
wherein the heating and pressing unit includes:
a pressing plate that comes into contact with and presses the plurality of sheets;
a heating body that heats the pressing plate;
a reception member that opposes the pressing plate; and
a pressing mechanism that applies pressure to the plurality of sheets held between the pressing plate and the reception member,
a booklet is made by heating and pressing the adhesive layer while holding the plurality of sheets on which the adhesive layer has been formed between the pressing plate and the reception member, and
the pressing mechanism applies pressure to the plurality of sheets held between the pressing plate and the reception member by pressing the pressing plate without applying a force to the heating body.

2. The booklet making apparatus according to claim 1, wherein
each of the pressing plate and the heating body has a long thin shape,
the pressing plate is longer than the heating body in a first direction that is perpendicular to each of a longitudinal direction of the pressing plate and a direction in which the pressing plate and the reception member oppose each other, and
the pressing mechanism applies pressure to the plurality of sheets held between the pressing plate and the reception member by pressing an area of the pressing plate that does not overlap the heating body in the first direction.

3. The booklet making apparatus according to claim 1, wherein
the heating body is in contact with the pressing plate.

4. The booklet making apparatus according to claim 1, wherein
the pressing plate is a first pressing member,
the reception member is a second pressing member which holds a bundle of sheets composed of the plurality of sheets between the second pressing member and the first pressing member in coordination, and which presses the heat-melting adhesive layer formed between two neighboring sheets among the plurality of sheets included in the bundle of sheets,
the pressing mechanism includes a moving unit that causes at least one of the first pressing member and the second pressing member to move so as to execute an approaching operation for generating a pressing force between the first pressing member and the second pressing member by causing the first pressing member and the second pressing member to approach each other, and a separating operation for cancelling the pressing force by causing the first pressing member and the second pressing member to be separated from each other,
the heating body includes a heating unit that heats the adhesive layer via the first pressing member by heating the first pressing member, and
the heating unit is arranged at a position that is distanced from a transmission path of the pressing force, or is arranged at a position that does not receive the pressing force.

5. The booklet making apparatus according to claim 4, wherein
the heating unit is provided in an internal space provided inside the first pressing member.

6. The booklet making apparatus according to claim 5, wherein
the pressing force supplied from the moving unit is propagated to a pressing surface of the first pressing member via a side wall of the internal space.

7. The booklet making apparatus according to claim 5, wherein
the heating unit is fixed to, or pushed against, a surface that intersects with a side wall of the internal space.

8. The booklet making apparatus according to claim 5, further comprising
a holding unit that is provided in the internal space of the first pressing member and holds the heating unit.

9. The booklet making apparatus according to claim 8, wherein
a first surface of the pressing plate is a pressing surface that presses the bundle of sheets, and
a pushing unit that pushes the heating unit against a second surface of the pressing plate is provided between the holding unit and the heating unit, the second surface being located on an opposite side of the first surface.

10. The booklet making apparatus according to claim 9, wherein
a temperature sensor is arranged between the pushing unit and the heating unit.

11. The booklet making apparatus according to claim 4, wherein
the heating unit is bonded or fastened so as to be in contact with the first pressing member.

12. The booklet making apparatus according to claim 4, further comprising
a viscous or elastic heat transfer material arranged between the heating unit and the first pressing member.

13. The booklet making apparatus according to claim 4, further comprising:
a pushing unit that generates a pushing force; and
a transmission member that transmits the pushing force to at least one of the first pressing member and the second pressing member,
wherein the moving unit causes the pushing unit to generate the pushing force by compressing or extending the pushing unit, and the pressing force is created based on the pushing force.

14. The booklet making apparatus according to claim 4, wherein
the first pressing member includes
a support member that has a first thermal conductivity,
a pressing plate that has a second thermal conductivity and is supported by the support member, and
a holding unit that holds the heating unit in an internal space formed by the support member and the pressing plate, and
a thermal conductivity of the holding unit is lower than the first thermal conductivity and the second thermal conductivity.

15. The booklet making apparatus according to claim 14, further comprising
a fixing device that fixes the pressing plate to the support member.

16. The booklet making apparatus according to claim 15, wherein
the fixing device includes a plurality of clips that are mounted on an exterior of a part of the support member and the pressing plate.

17. The booklet making apparatus according to claim 16, wherein
the plurality of clips are arranged at different positions in a longitudinal direction of the first pressing member, and
the plurality of clips include
a first clip and a second clip that are arranged in correspondence with a first standard size, and
a third clip that is arranged in correspondence with a second standard size.

18. The booklet making apparatus according to claim 16, wherein
the plurality of clips further include a fourth clip that is arranged at a center in a longitudinal direction of the first pressing member.

19. The booklet making apparatus according to claim 4, wherein
the heating unit is fixed to a surface parallel to a direction in which the pressing force is exerted in the first pressing member.

20. The booklet making apparatus according to claim 4, wherein
the first pressing member includes a first surface on which the pressing force acts, and a second surface on which the pressing force does not act, and
the heating unit is fixed to the second surface.

21. The booklet making apparatus according to claim 14, wherein
the holding unit includes a flange held between the support member and the pressing plate.

22. A booklet making apparatus, comprising:
a first pressing member;
a second pressing member which holds a bundle of sheets between the second pressing member and the first pressing member in coordination, and which presses a heat-melting adhesive layer formed between two neighboring sheets among a plurality of sheets included in the bundle of sheets;
a moving unit that causes at least one of the first pressing member and the second pressing member to move so as to execute an approaching operation for generating a pressing force between the first pressing member and the second pressing member by causing the first pressing member and the second pressing member to approach each other, and a separating operation for cancelling the pressing force by causing the first pressing member and the second pressing member to be separated from each other; and
a heating unit that heats the adhesive layer via the first pressing member by heating the first pressing member,
wherein the heating unit is arranged at a position at which the heating unit is capable of heating the first pressing member and which is distanced from a transmission path of the pressing force, or is arranged at a position at which the heating unit is capable of heating the first pressing member and which does not receive the pressing force.

23. An image forming system including an image forming apparatus and a post-processing apparatus,
the image forming apparatus comprising:
a forming unit that forms a toner image using toner for bonding in an adhesive area on a sheet; and
a conveyance unit that conveys the sheet to the post-processing apparatus,
the post-processing apparatus comprising:
a long thin heating and pressing unit that heats and presses an adhesive layer in a state where a plurality of sheets on which the adhesive layer has been formed are layered,
wherein the heating and pressing unit includes
a pressing plate that comes into contact with and presses the plurality of sheets,
a heating body that heats the pressing plate,
a reception member that opposes the pressing plate, and
a pressing mechanism that applies pressure to the plurality of sheets held between the pressing plate and the reception member,
a booklet is made by heating and pressing the adhesive layer while holding the plurality of sheets on which the adhesive layer has been formed between the pressing plate and the reception member, and
the pressing mechanism applies pressure to the plurality of sheets held between the pressing plate and the reception member by pressing the pressing plate without applying a force to the heating body.
